(19) United States
(12) Patent Application Publication
(10) Pub. No.: US 2012/0317474 A1
(43) Pub. Date: Dec. 13, 2012

(54) METHODS AND SYSTEMS FOR REAL-TIME WEB CONTENT PUBLISHING

(75) Inventor: Andre T. Parreira, Odivelas (PT)

(73) Assignee: IBT - Internet Business Technologies, Odivelas (PT)

(21) Appl. No.: 13/445,622

(22) Filed: Apr. 12, 2012

Related U.S. Application Data
(60) Provisional application No. 61/477,575, filed on Apr. 20, 2011.

(51) Int. Cl. G06F 17/00

(52) U.S. Cl. 715/234

(57) ABSTRACT

At least one embodiment of this invention pertains to a method for publishing real-time content on a website hosted by a web server. The method comprises inserting a real-time markup language tag in an HTML web page hosted by the web server; connecting, by an Open Real-Time Connectivity (ORTC) interface of the web server, a web client to the web server; monitoring, by the web client, an ORTC channel, wherein the ORTC channel is determined by the real-time markup language tag; receiving, at the web client, from the ORTC channel, a broadcasted message; and publishing in real-time at least a portion of the broadcasted message inside an HTML tag on the HTML web page without refreshing the HTML web page, wherein the HTML tag is determined by the real-time markup language tag.

### CROSS REFERENCE TO RELATED APPLICATIONS

This patent application claims priority to U.S. Patent Application No. 61/477,575, entitled METHOD, SYSTEM AND PRODUCTS FOR STANDARDIZED xRTML-MARKUP LANGUAGE IN REAL-TIME WEB CONTENT PUBLISHING, filed Apr. 20, 2011, the entire contents of which are incorporated herein its entirety.

This patent application is further related to the technologies described in the following patents and applications, all of which are incorporated herein in their entireties:

U.S. Provisional Patent Application No. 61/477,579, entitled METHOD, SYSTEM AND PRODUCTS FOR STANDARDIZED ACCESS TO REAL-TIME FULL-DUPLEX WEB COMMUNICATIONS PLATFORM, filed Apr. 20, 2011; and U.S. Patent Application No. 61/477,577, entitled METHODS, SYSTEMS AND PRODUCTS IN REAL-TIME TRACKING AND MARKETING INTERACTION WITH WEB APPLICATION USERS, filed Apr. 20, 2011.

### FIELD

The present invention relates to real-time web content publishing, and more specifically to methods and systems using extensible real-time markup language in real-time web content publishing.

### BACKGROUND

In the constantly evolving world of web communications, where information has to be deployed quickly and reliably, full-duplex communication in websites is key for improving customer experience and decreasing the amount of requests to web servers in order to obtain the most current data update. Consider a scenario within an auction website, where several users follow bids related to a specific item. FIG. 1A illustrates such a scenario.

As illustrated in FIG. 1A, each client device (e.g., 102A, 102B, 102C) transmits a request (e.g., an AJAX request) to the web server 104 at periodic intervals (e.g., every second) to obtain information related to the latest bid or any other updates to the auction. If there is no bid or other status update for 1 minute, 60 requests per user are sent and handled by the server when in fact there is no change in status. This architecture imposes a huge load on the web server and uses a lot of bandwidth due, for example, overhead associated with HTTP GET headers.

To avoid such a cumbersome load on the servers, an improved scenario would be for the server to broadcast (push) information related to latest bids or other such updates to all the users when a new bid is placed. FIG. 1B depicts such scenario. Here, each client receives an update through a direct connection with an underlying platform. However, even such an improved scenario presents bandwidth strains on the web server and other related issues as will be explained in the following detailed description.

Overall, the examples herein of some prior or related systems and their associated limitations are intended to be illustrative and not exclusive. Other limitations of existing or prior systems will become apparent to those of skill in the art upon reading the following Detailed Description.

### SUMMARY OF THE DESCRIPTION

At least one embodiment of this invention pertains to a real-time markup language, eXtensible Real-Time Markup Language (xRTML), which provides a consistent set of markup tags that simplifies and accelerates the development of real-time web applications, xRTML delivers a new layer of abstraction on top of standard HTML, allowing a seamless integration between the HTML elements of a web page and the complex and powerful features of a distributed real-time communications platform, through the use of a simple set of markup tags.

One embodiment of this invention pertains to a method for publishing real-time content on a website hosted by a web server. The method comprises inserting a first real-time markup language tag and a second real-time markup language tag in an HTML web page hosted by the web server; connecting, by an Open Real-Time Connectivity (ORTC) interface of the web server, a first web client to the web server; monitoring, by the first web client, an ORTC channel, wherein the ORTC channel is determined by the first real-time markup language tag; connecting, by an Open Real-Time Connectivity (ORTC) interface of the web server, a second web client to the web server; receiving an input, at the second web client, from a user input XML tag on the HTML webpage, wherein the user input XML tag is determined by the second real-time markup language tag; sending in real-time a broadcast message containing the input to the ORTC channel, wherein the ORTC channel is determined by the second real-time markup language tag; receiving, at the first web client, from the ORTC channel, the broadcast message; and publishing in real-time at least a portion of the broadcast message inside a display XML tag on the HTML web page without refreshing the HTML web page, wherein the display XML tag is identified by the first real-time markup language tag. In a related embodiment, operations are performed based on instructions specified in messages broadcasted through the ORTC channel using a script execution environment.

Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIGS. 1A and 1B illustrate prior art systems of communication between web clients and a server:

FIG. 2 shows a diagram of a sample environment for a web server interacting with client devices through the Internet;

FIG. 3 illustrates the functionality of a Connection tag for a sample implementation of an eXtensible Real-Time Markup Language.

FIG. 4 illustrates the functionality of a Connection Manager for a sample implementation of an eXtensible Real-Time Markup Language.

FIG. 5 illustrates the functionality of a trigger for a sample implementation of an eXtensible Real-Time Markup Language.

FIG. 6 shows a block diagram of a communication scheme between a end user and a web server:

FIG. 7 shows a block diagram of a sample message update process for a web page HTML Element;

FIG. 8 shows a sample data flow between different components of a sample auction web site;

FIG. 9 shows a sample HTML code embedded with an xRTML tag for displaying and updating an auction price; and

FIG. 10 shows a sample HTML code embedded with an xRTML tag for placing and broadcasting a bid on an auction.

The headings provided herein are for convenience only and do not necessarily affect the scope or meaning of the claimed invention.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

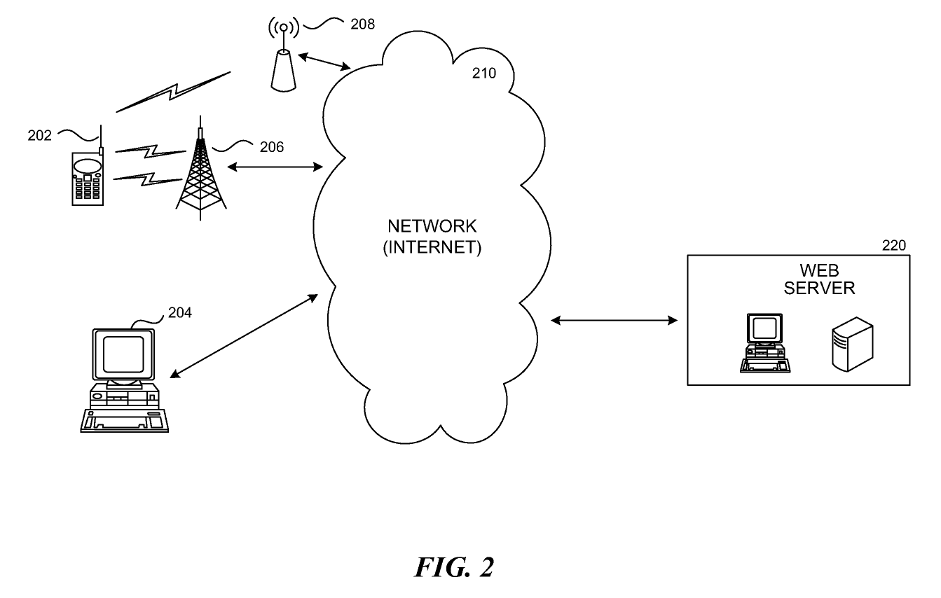

FIG. 2 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 2, a user may use a personal computing device (e.g., a phone 202, a personal computer 204, etc.) to communicate with a network. The term “phone,” as used herein, may be a cell phone, a personal digital assistant (PDA), a portable email device (e.g., a Blackberry®), a portable media player (e.g., an IPod Touch®), or any other device having communication capability to connect to the network. In one example, the phone 202 connects using one or more cellular transceivers or base station antennas 206 (in cellular implementations), access points, terminal adapters, routers or modems 208 (in IP-based telecommunications implementations), or combinations of the foregoing (in converged network embodiments).

In some instances, the network 210 is the Internet, allowing the phone 202 (with, for example, WiFi capability) or the personal computer 204 to access web content offered through various web servers. In some instances, especially where the phone 202 is used to access web content through the network 210 (e.g., when a 3G or an LTE service of the phone 102 is used to connect to the network 110), the network 210 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (CPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, a user uses one of the personal computing devices (e.g., the phone 202, the personal computer 204, etc.) to connect to a web server 220 over the network 210. A web server, as defined herein, refers to any computing device that hosts or operates data pertaining to a website. In one example, the web server 220 is a server operates by an online clothing store company. In such an example, the web server 220 has local or remote access to a database comprising the online store's catalog of products and pricing information. The web server 220 may also include information, in the form of a database of scripts or high-level languages, relevant to receiving user input over the input and responding with content pertinent to the user's input. For example, if a user requests samples of a particular designer shirt, the web server 220 includes capability to retrieve the relevant designer information and products from the database and return the information to the requesting client such that the information is displayed on the user's personal computing device. The web server 220 also includes code relevant to hosting the web site and managing all interactive actions related to the hosted web site. In another example, the web server operates an interactive online networking model, where several users may operate concurrently in an interactive session.

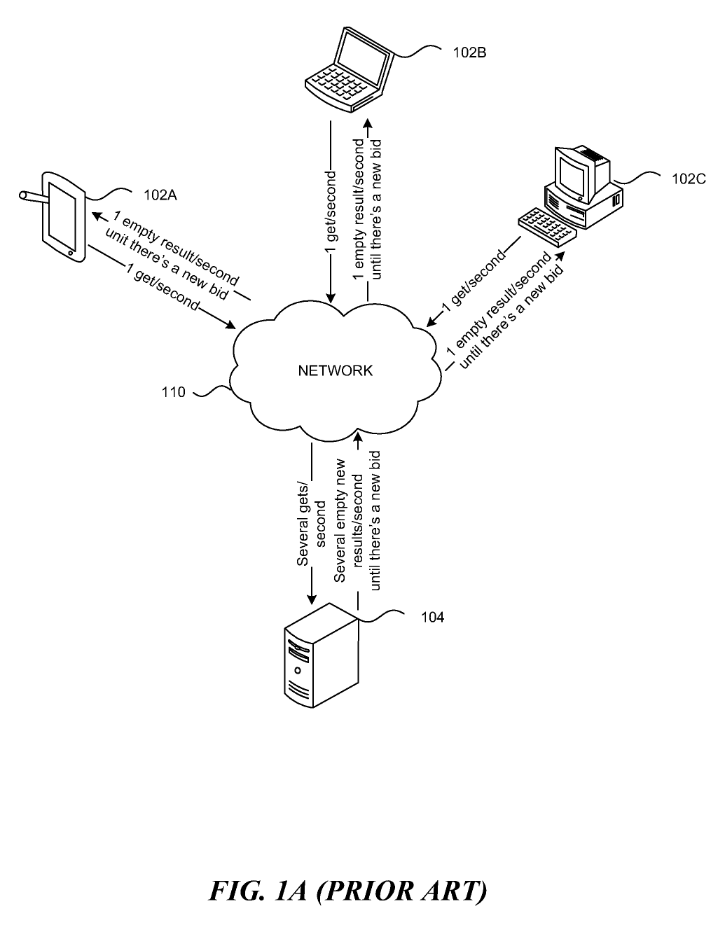

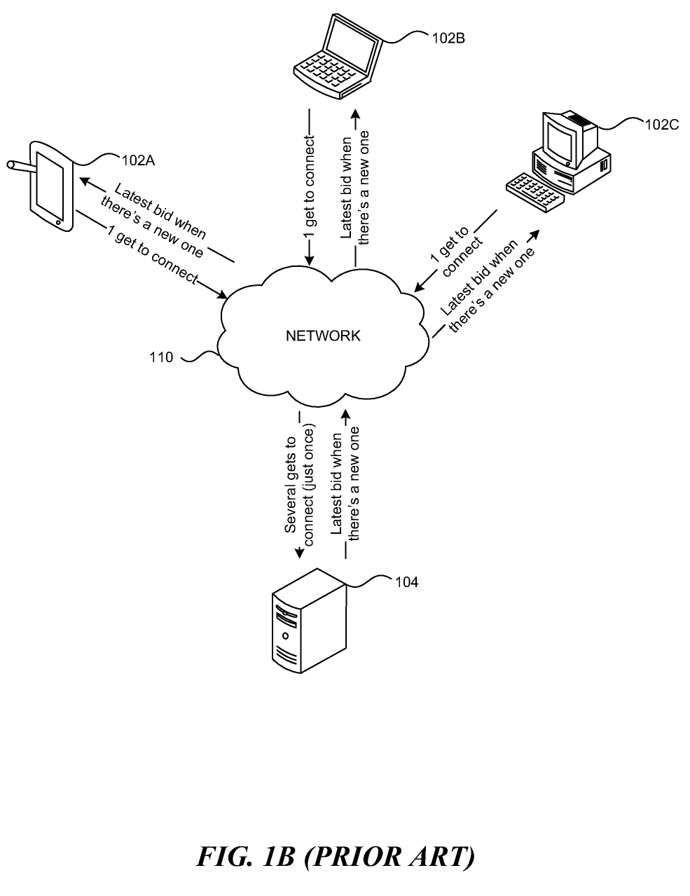

An illustrative example of such an interactive session is an auction web site (such as, for example, ebay.com). Here, the web server 220 may operate numerous interactive sessions. An interactive session, as defined herein, refers to each session in which multiple users interact with reference to a particular item of interest. For example, a first interactive session may be an online auction relating to the sale of an antique vase. Every user of the web site that signs in or connects in to view the auction relating to that particular antique vase is in a common interactive session. In such an interactive session, actions made by each user that affect a change in status of the session needs to be constantly refreshed and updated within the views of each user of the session. To explain this in an illustrative example, consider a scenario where three users are connected to a page that displays the status the auction for the antique vase. If any of the users makes a bid, the user's name or identity, along with a current bidding amount will need to be updated, and the interactive session showing the update will need to be refreshed in each page. FIGS. 1A and 1B, as explained in the background, illustrate exemplary methodologies used by servers to push out the updates to each of the connected clients. In the prior art discussed in the background section, the clients seldom communicate directly or have any medium for interaction without primary interaction with the web server 220 to receive updates relating to updates or status changes in the interactive session hosted by the web server 220. Several known method exist to establish such interactive communication between the web server 220 and the clients. For example, full-duplex web communication platforms (e.g., HTML5 Websocket) enable duplex communication between the clients and the web server 220, allowing the clients to transmit instructions (e.g., placing a bid) and receive updates (e.g., refreshed pages or information within pages upon another client placing a bid).

As will be explained in more detail below, in one embodiment, the techniques described herein introduce a layer of abstraction to the underlying web communication platform (simply, “communication platform”). Such an abstraction layer, introduced as the Open Real-Time Connectivity (ORTC) layer, presents several advantages. In such embodiments, the web site (and corresponding web pages) corresponding to the dynamic session operated by the web server 220 include interfaces (e.g., APIs) to a base ORTC layer. Upon interfacing, through ORTC interfaces, with the ORTC layer, the web pages are ORTC enabled and operate via the ORTC layer to establish communication with the underlying communication platform. There are several advantages in having such an abstraction layer. One advantage is that the web server 220 may change the underlying communication platform (e.g., when there are updates or newer and advanced platforms) without having to change the web site architecture (e.g., without changing code relevant to the operation of the interactive session). Another advantage is that, in certain implementations, information related to updates to interactive sessions are broadcast and captured directly via the ORTC interfaces associated with the web clients, without requiring any update pushed out from the web server. Additionally, the web client does not have to repeatedly request or look for updates from the server. Instead, the web client automatically receives an update message through the ORTC layer, thus conserving considerable bandwidth resources that would have originally been spent on continuously querying the web server 220.

The ORTC layer is developed to add a layer of abstraction to real-time full-duplex web communications platforms by making real-time web applications independent of the actual network communication platform in use. However programmers still need to interpret the server messages being sent over the network and render the appropriate received content at the appropriate place in the GUI on the end user's web browser.

xRTML, eXtensible Real-Time Markup Language, provides a consistent set of markup tags that simplifies and accelerates the development of real-time web applications. Taking advantage of the standardized client functions of the Open Real-Time. Connectivity API (ORTC), these xRTML tags are associated to a given stream of data (the ORTC channel), receiving real-time data updates sent by the server over the common internet ports, such as port 80 or 443, with the purpose of rendering this live data in real-time into the web page without the need of web page being refreshed by the web browser. Within the present disclosure, real-time means that the content is updated without the need of refreshing the current page or navigating to another page on the website.

In one embodiment, xRTML is implemented on a JavaScript (such as an ECMA standard implementation of JavaScript) library, which contains a set of methods and functions for providing a layer of abstraction to work with real-time communication, in an environment that allows JavaScript execution. The library provides several ways of writing the code to be interpreted by the xRTML engine. For example in one embodiment, XML(Extensible Markup Language) tags in an environment containing a DOM (Document Object Model) standard implementation may be utilized. The xRTML engine will read the DOM tree searching for XML tags identified with the “xrtml:” prefix. These identified tags are specified by a standard XML Schema, and each has specific behavior defined by the xRTML library, as we will describe further in the document. In another embodiment, a JavaScript API (Application Programming Interface) may be utilized with the library. This API contains methods or function calls to create tags, open connections to ORTC, register new tags, extend existing tags, and other functionality relevant for working with the XRTML implementation. This API is intended for developers so that the developer is not obligated to resort to XML tags when using this API. An xRTML tag may be a tag declared via XML tags or by using JavaScript API methods.

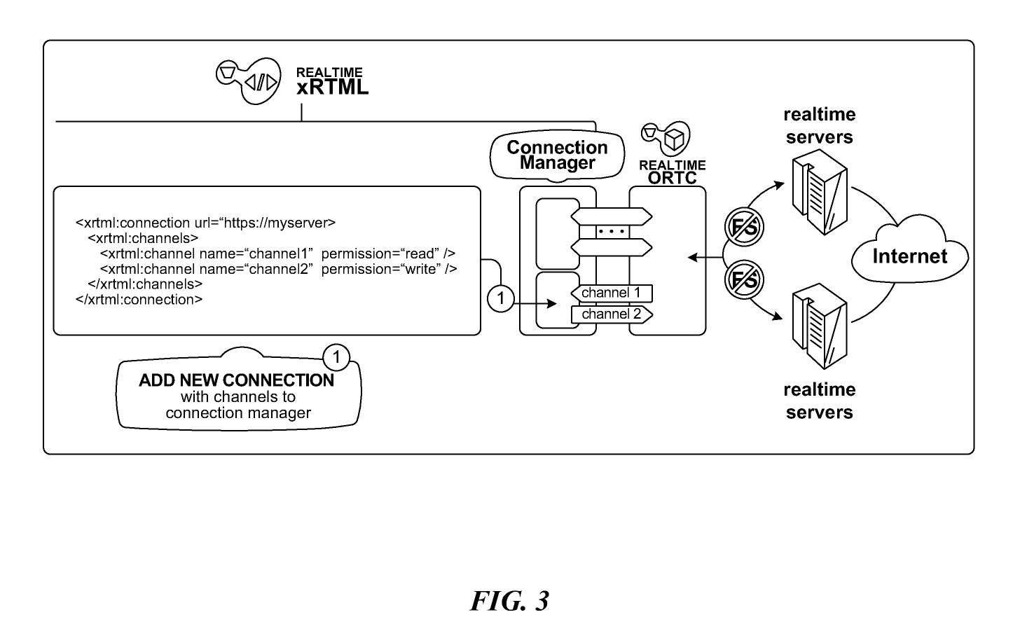

In one embodiment, an xRTML tag called Connection is used to define connections to an ORTC (Open Real-time Connectivity) server. The xRTML engine will read the information on these tags and use a library core component called ConnectionManager to create and manage all existing connections. This functionality is represented visually on FIG. 3.

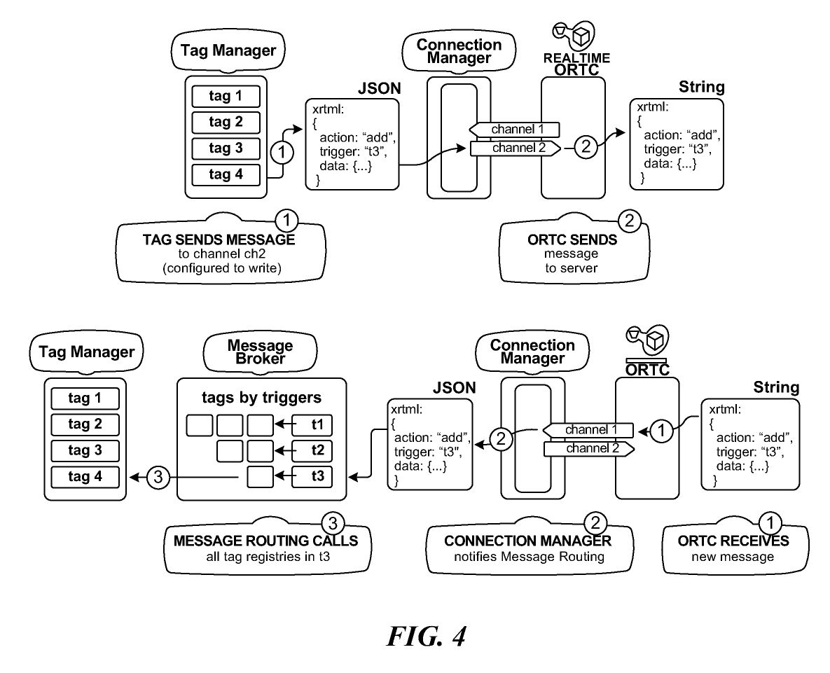

The ConnectionManager is responsible for encapsulating the functionality to create ORTC clients. By using the ORTC API, we can create instances of objects in memory that will allow for communicating with the real-time servers. The ConnectionManager functionality further includes connecting to ORTC using those clients and managing the relaying of JSON (JavaScript Object Notation) messages to corresponding Connection tags, which will in turn delegate the messages to the tags registered to receive those messages. FIG. 4 illustrates the functionality of the ConnectionManager.

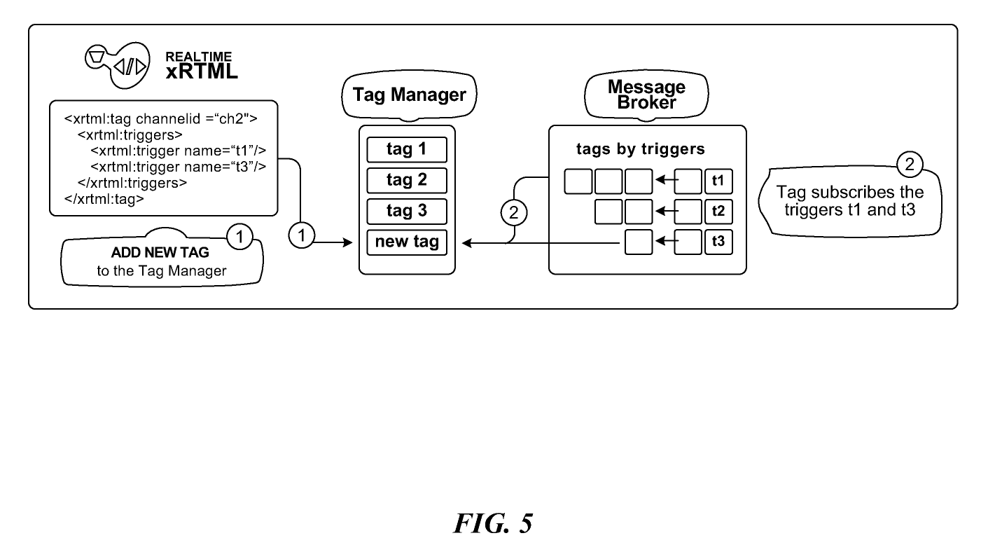

In one embodiment, there are inner tags or properties, called triggers, in tags. The triggers are registered in the xRTML engine using the library component TagManager. When a message arrives through the ORTC (Open Realtime Connectivity) channels, and that message contains a trigger that is registered in the TagManager, the tags subscribing that trigger will be executed. FIG. 5 illustrates the functionality of the triggers.

In some embodiments, xRTML comprises a set of tags that provide functionality relevant for working with real-time technology, be it manipulating a DOM tree or executing other functions in a JavaScript execution environment. Below we describe the behaviors provided by each of tags.

Config tag manages xRTML console logging, override connection defaults and other aspects of xRTML configuration. An XML code example is listed below:

<xrtml:config debug=″false″ xrtmlactive=”true” loadortclibrary=”true”
connectionattempts=”5” connectiontimeout=”5” loglevel=”1”
remotetrace=”true”>
</xrtml:config>

A JavaScript code example is listed below:

xRTML.Config.debug = false;
xRTML.Config.xrtmlActive = true;
xRTML.Config.loadOrtcLibrary = true;
xRTML.Config.connectionAttempts = 5;
xRTML.Config.connectionTimeout = 5;
xRTML.Config.logLevel = 1;
xRTML.Config.remoteTrace = true;

Connection tag allows users to establish a connection to a realtime server. An XML code example is listed below:

<xrtml:connection appkey=“myAppKey” authtoken=“myDevToken”

url=“http://developers2.realtime.livehtml.net/server/2.0/”>
<xrtml:channels>

<xrtml:channel name=“myChannel”/>

</xrtml:channels>

</xrtml:connection>

A JavaScript code example is listed below:

var connectionJSON = {

appkey:‘myAppKey’,
authtoken:‘myAuthToken’,
url:‘http://developers2.realtime.livehtml.net/server/2.0’,
channels:[{name:‘myChannel'}]

}
xRTML.addEventListener(‘ready’,function( ){

xRTML.createConnection(connectionJSON);

});

Repeater tag manages an array like element where content is displayed in a user defined structure each time this tag is triggered. An XML code example is listed below:

<xrtml repeater index=“begin” maxitens=“5” receiveownmessages=“true”

removeindex=“end” target=“#list1”>
<xrtml:triggers>

<xrtml:trigger name=“myTrigger”/>

</xrtml:triggers>
<xrtml:template>

<!--<li> [xRTML:name] </li>-->

</xrtml:template>

</xrtml:repeater>

A JavaScript code example is listed below:

var repeaterJSON = {

name:‘Repeater’,
target: “#list1”,
index: “begin”,
receiveownmessages: true,
removeindex: “end”,
maxitens: 5,
triggers:[{

name: “myTrigger”

}],
template : {

content: ‘<li> [xRTML:name] </li>’

```
  }
};
Events.Manager.addEventListener(xRTML, ‘ready’, function( ) {
  xRTML.createTag(repeaterJSON);
}):
```

Other xRTML tags includes Audio tag for playing sounds, for example, on browsers that support HTML5. Booking tag allows users to concurrently book reservations. The Broadcast tag dispatches messages to all elements listening on the real-time channel. Calendar tag allows users to make appointments in a calendar. Chart tag is for displaying data visualizations in chart plotting. Cloud tag generates a cloud object based on a custom object. DrawingBoard tag allows users to draw and sketch on a canvas. Execute tag designates the handling of an xRTML message to a callback method. GeoLocation tag is for sending geo location coordinates to real-time channel. KeyTracker tag sends the codes of the keys pressed to real-time channel. Map tag is for interaction with map services such as Google Maps and Bing Maps. Motion tag is for sending motion data coordinates to a real time channel. Mouselive tag monitors the movement of the mouse in a specified element (or the body of the document if not specified). The ‘sender side sends the coordinates through a real-time message captured by the ‘receiver’ side and replicates the mouse movement by an HTML element moving on the page accordingly. MouseTracker tag monitors for mouse events and sends those events and properties related by means of a real-time message. Placeholder tag allows the placement of a media file in a user selected DOM element. Poll tag is for managing a real-time voting poll. ShoutBox tag allows users to share text messages. All messages are delivered in a broadcast manner to all connected users. TextToSpeech tag converts messages received into voice, for example, on browsers that support HTML5. Toast tag is for displaying a toast on the page. Video tag is for playing videos, for example, on browsers that support HTML5. VideoChat tag allows users to communicate through a video feed.

For example, in an auction, a <XRTML:PLACEHOLDER> tag may be used to render the latest bid of a specific item instantly when a new bid is placed, without the need of repeated update requests to the web server. Because the xRTML tags are just like HTML tags they can be perfectly mixed with standard HTML tags such as <DIV>. The xRTML tags enable standard HTML tags, like a simple <DIV>, always displaying freshly received data from the server without the need of a global page refresh.

Using the method and system of xRTML, the task of developing real-time web applications is simplified to a level where an HTML programmer can harness the power of real-time content publishing, without the need of possessing proficient skills in JavaScript and networking protocols.

The present invention contemplates a variety of improved methods and systems for allowing any website to publish real-time content without the need of a page refresh. By utilizing a set of real-time markup language tags that connect to streams of data through the ORTC API, called eXtensible Real-Time Markup Language (xRTML), HTML programmer, even if not proficient in the art of JavaScript and network communication protocols, can add real-time features to any website.

In one embodiment, the latest bid of a given item is displayed in an auction website, without the constant requests to the web server. In order to achieve this goal, the HTML programmer may utilize an xRTML <XRTML:PLACEHOLDER> tag, wherein the tag identifies the ORTC channel through which the real-time server will broadcast the latest bid and the HTML element on the HTML web page that will display the broadcasted bid.

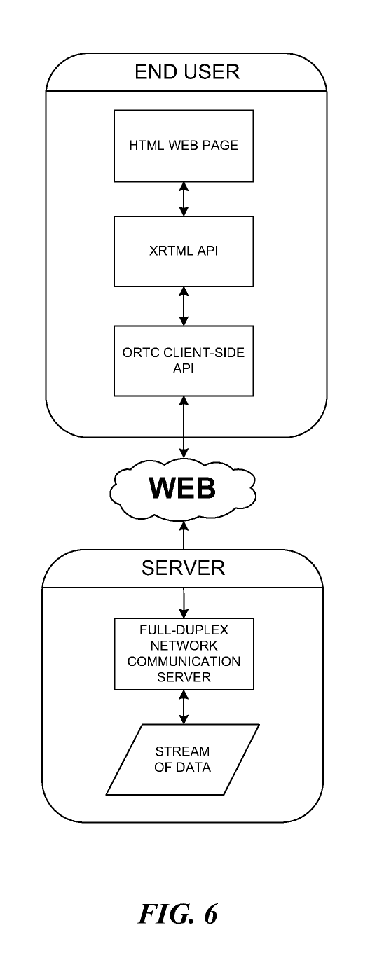

FIG. 6 shows a block diagram of a communication scheme between the end user and the web server. Through a xRTML tag, the HTML page is connected and listening to an ORTC channel, which is connected over the web to the full-duplex network communication server, called full-duplex gateway, through the ORTC API. The full-duplex gateway is connected to a stream of data. Whenever there is a data update broadcasted, the full-duplex gateway will send a message with the updated data via ORTC API to the end user according to the xRTML element. An xRTML API will then render it into the appropriate HTML page element.

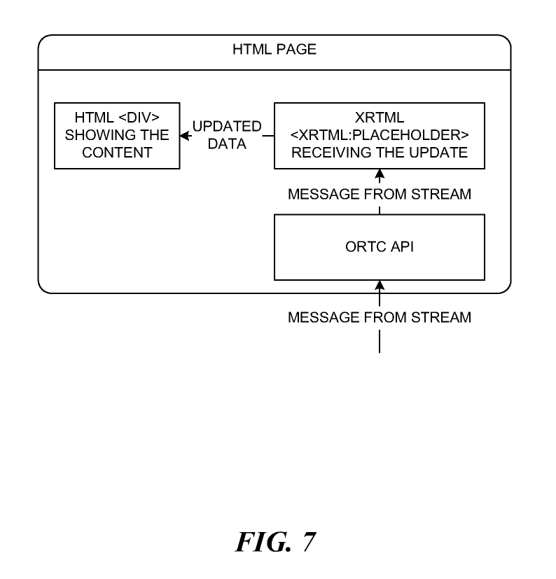

FIG. 7 shows a block diagram of a message update process for a web page HTML element. In one embodiment, a new message may be received as a JSON string from the real time stream. Upon reception of the new message, the xRTML API will parse the message to obtain the updated data and then sets the appropriate HTML parameter of the HTML element, e.g. the inner html of a <div>, to which it's connected so it may render the updated data to the user's web browser.

As seen in FIG. 7, the HTML layout of a web page is independent from the live streams being listened. xRTML elements on the web page are updated based on the live stream. In this way, real-time features may be integrated into legacy web sites by attaching the appropriate xRTML elements to the appropriate HTML elements of the existing page.

xRTML elements contain more tags such as <XRTML:REPEATER>. The mechanism how these tags work is similar to the mechanism shown in FIG. 7. There's an xRTML element encapsulating the real-time communication details. Real-time message is parsed and an HTML element is rendered to update the data onto the displayed web page. This updated data can range from the latest bid of an item in an auction, a new promotional price of an e-commerce item, or even to a “breaking news' title in a news website.

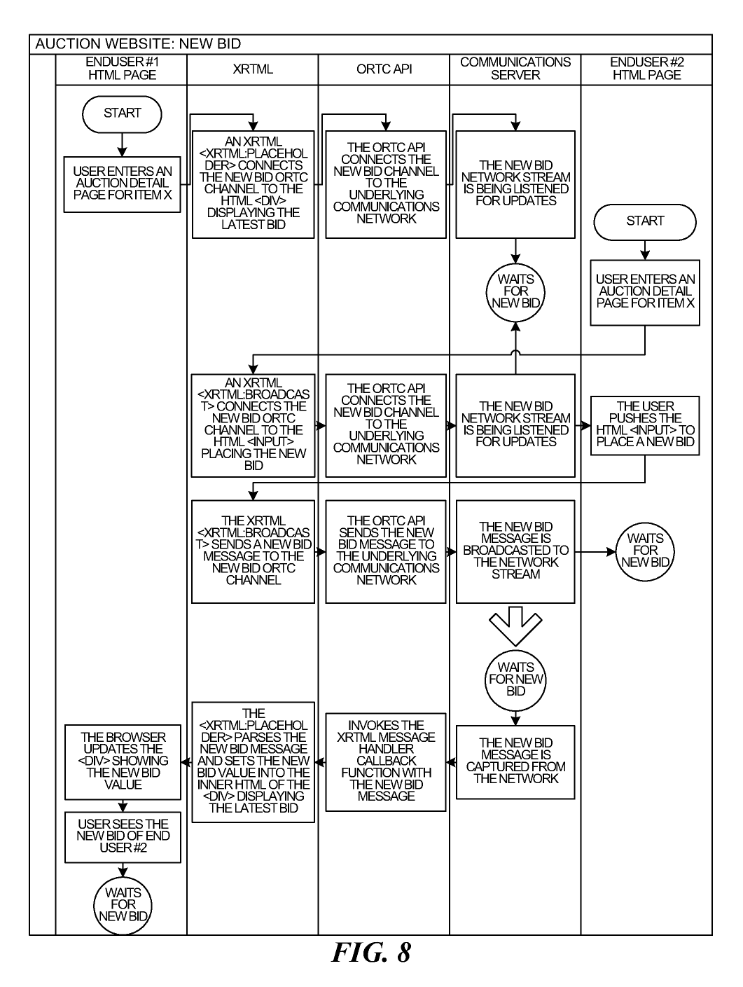

In one embodiment, real-time content is published on a web site without the need of a web page refresh. FIG. 8 shows the detailed data flow between the different components of an auction web site. As shown in FIG. 8, while browsing an auction website, the END USER #1 enters a detail web page of item X to follow the placed bids on the item. In the detail web page, there's an HTML element, such as a <DIV>, responsible for displaying the latest bid. There's also a xRTML tag <XRTML:PLACEHOLDER> responsible for receiving new bids and displaying them in the referred <DIV> HTML element.

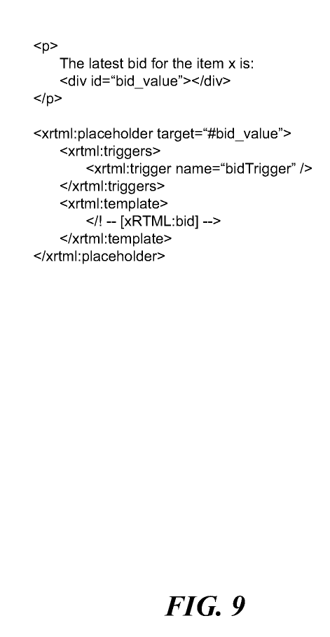

FIG. 9 shows a sample HTML code embedded with an xRTML tag for displaying and updating an auction price. There are multiple parameters within the <XRTML:PLACEHOLDER> tag. Parameter target indicate which HTML element will be updated when an appropriate new message arrives. For example, parameter target may indicate that <DIV> #latest_bid is the HTML element responsive to the new message. Parameter trigger acts as a filter for messages coming on the ORTC channel. Only messages directed to the same trigger as the tag is listening to will invoke the tag's internal functions. In FIG. 9, new bids are broadcasted to the ORTC channel new bid. Parameter trigger indicates that the messages in the ORTC channel is filtered to receive the messages related only to item X.

The content of the <XRTML:TEMPLATE> tag is a template with key tokens that will be respectively replaced by its values every time a message is received, i.e. [XRTML:BID], refers to the current bidding price of item X being updated. The xRTML API engine will replace the [XRTML:BID] string with the actual value in the message received. If a new bid is placed with a value of 20 then the new HTML value of the <DIV> with the ID latest_bid will be 20 USD.

When the HTML page loads at END USER's #1 web browser the <XRTML:PLACEHOLDER> element connects to the new bid channel “new bid” using the ORTC client-side API. A default JavaScript function may be embedded into the <XRTML:PLACEHOLDER> element automatically by the xRTML API engine, so the programmer doesn't need to code any JavaScript. If the programmer wants to extend the standard <XRTML:PLACEHOLDER> behavior, he may code his own JavaScript callback function and may identify it at the preprocess and postProcess parameters of the <XRTML:PLACEHOLDER> element. As soon as the ORTC API handles all the communication details with the underlying network protocols, END USER #1 waits for new bids to be placed.

Meanwhile END USER #2 browses the same auction website and enters the detail web page of item X to place a new bid. The steps referred earlier for END USER #1 are performed in order to allow END USER #2 to receive new bid updates. In addition, at the detail page HTML there may be another HTML element, such as a <INPUT TYPE=“BUTTON”> responsible for placing a new bid. There's also an xRTML <XRTML:BROADCAST> tag responsible for sending the new bid message to the appropriate ORTC channel.

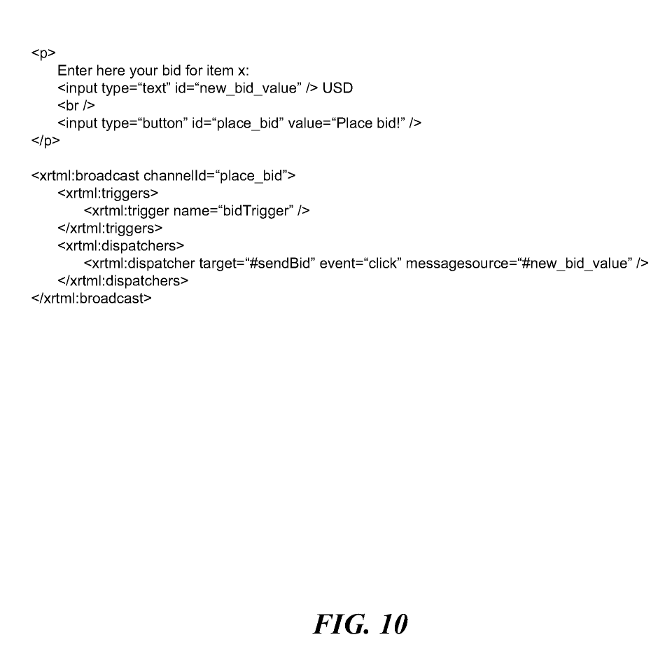

FIG. 10 shows a sample HTML code embedded with an xRTML tag for placing and broadcasting a bid on an auction. There are multiple parameters and children for the <XRTML:BROADCAST> tag, as shown in FIG. 10. Parameter target, inside child DISPATCHERS\DISPATCHER indicates which HTML element triggers the broadcast in the ORTC channel. As shown in FIG. 10, the HTML element in this example is the pace_bid button. Parameter EVENT, also inside the DISPATCHERS\DISPATCHER child indicates the event of elementid causing the broadcast. In this example it's the onclick event, meaning that only when the user clicks the button the message will be broadcasted. Parameter channelId indicates to which ORTC channel the message will be broadcasted, Parameter NAME, inside the TRIGGERS\TRIGGER child, indicates that the message should only be processed by tags listening the ORTC channel but filtered to receive the messages related only to trigger bidTrigger.

The value of the messagesource attribute, inside the DISPATCHERS\DISPATCHER child, i.e. [#new_bid_value], refers to the value parameter of the new_bid_value HTML element containing the actual value of the new bid. The xRTML API engine will capture the value inserted in the element and broadcast it, after formatting it into the xRTML message format, through ORTC.

For example, if the users enters 20 at the new_bid_value text input and clicks the place_bid button, the broadcasted message will be {“xrtml”:{“trigger”:“bidTrigger”, “data”:{“bid”:{“20”}}}. Accordingly, the [XRTML:BID] reference at the XRTML:PLACEHOLDER value In FIG. 9, which refers to the value of the “bid” parameter of the message received, receives a value of 20 in this case.

As soon as END USER #2 presses the “Place bid!” input button, the xRTML API engine formats <XRTML:BROADCAST> tag and the ORTC API engine sends the new bid message into the ORTC channel which will then broadcast it over the network using the underlying network communications protocols.

As the new bid message is captured by the page of END USER #1, the <XRTML:PLACEHOLDER> default callback function is invoked by xRTML API engine which will parse the message and set the inner HTML parameter of the <DIV> responsible to display the latest bid. When the inner HTML parameter is updated, the END USER #1's web browser will render the new value onto the END USER #1's screen. In fact the same thing will happen at the same time at the END USER #2's web browser, since END USER #2 also is connected to the new bids channel of item X. The same will happen at the same time at other users' web browsers following the auction of item X. This process will be repeated until the auction closes.

The HTML elements are responsible for interfacing with the user and the xRTML elements are responsible for broadcasting/receiving the real-time messages based on the actions the user is performing with the HTML elements. The xRTML API engine enhances a website with simple and yet powerful real-time features.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

We claim:

1. A method for publishing real-time content on a website hosted by a web server, comprising:
inserting a real-time markup language tag in an HTML web page hosted by the web server;
connecting, by an Open Real-Time Connectivity (ORTC) interface of the web server, a web client to the web server;
monitoring, by the web client, one or more ORTC channels, wherein the ORTC channels are determined by the real-time markup language tag;
receiving, at the web client, from the ORTC channels, a broadcasted message; and
publishing in real-time at least a portion of the broadcasted message inside an HTML tag on the HTML web page without refreshing the HTML web page, wherein the HTML tag is determined by the real-time markup language tag.

2. The method of claim 1, wherein the real-time markup language tag is a tag of the eXtensible Real-Time Markup Language (xRTML).

3. The method of claim 1, wherein the ORTC channel is determined by a channel parameter of the real-time markup language tag.

4. The method of claim 1, wherein the HTML tag is determined by an HTML element parameter of the real-time markup language tag.

5. The method of claim 1, further comprising:
filtering the messages from the ORTC channel based on the real-time markup language tag.

6. The method of claim 5, wherein the filtering is based on a filter parameter of the real-time markup language tag.

7. The method of claim 1, wherein the broadcasted message is sent by a second web client without requiring any update feed from the web server.

8. The method of claim 1, wherein the ORTC interface is an abstraction layer to the underlying real-time full-duplex web communication platform.

9. The method of claim 8, wherein the underlying real-time full-duplex web communication platform is an HTML5 WebSocket platform.

10. The method of claim 8, wherein the abstraction layer enables the web client to operate independent of a type of underlying communication platform.

11. A method for broadcasting real-time content on a website hosted by a web server, comprising:
Inserting a real-time markup language tag in an HTML web page hosted by the web server;
connecting, by an Open Real-Time Connectivity (ORTC) interface of the web server, a web client to the web server;
receiving an input, from a tag or function on the HTML webpage, wherein the tag or function is determined by the real-time markup language tag; and
sending in real-time a broadcast message containing the input to one or more ORTC channels, wherein the ORTC channels are determined by the real-time markup language tag.

12. The method of claim 11, wherein the real-time markup language tag is a tag of the eXtensible Real-Time Markup Language (xRTML).

13. The method of claim 11, wherein the ORTC channel is determined by a channel parameter of the real-time markup language tag that manages connections.

14. The method of claim 11, wherein the ORTC channel is determined by a channel id parameter of a real-time markup language tag that processes messages transmitted to the ORTC channel.

15. The method of claim 11, wherein the tag or function is determined by an HTML element parameter of the real-time markup language tag.

16. The method of claim 11, wherein the broadcast message further contains a filter parameter of the real-time markup language tag.

17. The method of claim 11, wherein the broadcast message is received by a second web client without requiring any update feed from the web server.

18. The method of claim 11, wherein the ORTC interface is an abstraction layer to the underlying real-time full-duplex web communication platform.

19. The method of claim 18, wherein the underlying real-time full-duplex web communication platform is an HTML5 WebSocket platform.

20. The method of claim 18, wherein the abstraction layer enables the web client to operate independent of a type of underlying communication platform.

21. A method for publishing real-time content on a website hosted by a web server, comprising:
inserting a first real-time markup language tag and a second real-time markup language tag in an HTML web page hosted by the web server;
connecting, by an Open Real-Time Connectivity (ORTC) interface of the web server, a first web client to the web server;
monitoring, by the first web client, one or more ORTC channels, wherein the ORTC channels are determined by the first real-time markup language tag;
connecting, by an Open Real-Time Connectivity (ORTC) interface of the web server, a second web client to the web server;
receiving an input, at the second web client, from a tag or function on the HTML webpage, wherein the tag or function is determined by the second real-time markup language tag;
sending in real-time a broadcast message containing the input to the one or more ORTC channels, wherein the ORTC channels are determined by the second real-time markup language tag;
receiving, at the first web client, from the ORTC channels, the broadcast message; and
publishing in real-time at least a portion of the broadcast message inside a display HTML tag on the HTML web page without refreshing the HTML web page, wherein the display HTML tag is identified by the first real-time markup language tag.

22. The claim of claim 21, further comprising:
performing operations based on instructions specified in messages broadcasted through the ORTC channel using a script execution environment.
